(19) United States
(12) Patent Application Publication
(10) Pub. No.: US 2021/0312607 A1
(43) Pub. Date: Oct. 7, 2021

(54) PRINT QUALITY ASSESSMENTS

(71) Applicant: Hewlett-Packard Development Company, L.P., Spring, TX (US)

(72) Inventors: Qian Lin, Palo Alto, CA (US); Augusto Cavalcante Valente, Campinas (BR); Otavio Basso Gomes, Porto Alegre (BR); Deangeli Gomes Neves, Campinas (BR); Guilherme Augusto Sliva Megeto, Porto Alegre (BR); Marcos Henrique Cascone, Porto Alegre (BR); Thomas da Silva Paula, Porto Alegre (BR)

(73) Assignee: Hewlett-Packard Development Company, L.P., Spring, TX (US)

(21) Appl. No.: 17/260,264

(22) PCT Filed: Nov. 2, 2018
(86) PCT No.: PCT/US2018/058977

§ 371 Date: Jan. 14, 2021

(51) Int. Cl. G06T 7/00; G06K 9/62; G06T 7/11; G06T 3/40; G06K 15/02; G06K 15/00

(52) U.S. Cl. CPC G06T 7/0004; G06K 9/6267; G06T 7/11; G06T 3/40; G06T 2207/20084; G06K 15/408; G06K 9/6256; G06T 2207/30144; G06T 2207/20081; G06K 15/027

(57) ABSTRACT

An example of an apparatus is provided. The apparatus includes a preprocessing engine to preprocess an image of a print into a reduced format wherein the reduced format includes a plurality of pixels. The apparatus further includes a segmentation analysis engine to generate a plurality of labels. Each label of the plurality of labels is associated with a pixel of the plurality of pixels. The plurality of labels identifies each pixel of the plurality of pixels as a defective pixel or a non-defective pixel. The apparatus also includes a rendering engine to display defects in the reduced format based on the plurality of labels.

### BACKGROUND

A printing device may generate prints during operation. In some cases, the printing device may introduce defects into the print which are not present in the input image. The defects may include streaks or bands that appear on the print. The defects may be an indication of a hardware failure or a direct result of the hardware failure. In some cases, the defects may be identified with a side by side comparison of the intended image with the print generated from the image file.

### BRIEF DESCRIPTION OF THE DRAWINGS

Reference will now be made, by way of example only, to the accompanying drawings in which:

FIG. 1 is a block diagram of an example apparatus to assess a print quality of print from analyzing an image;

FIG. 2 is a block diagram of an example system to assess a print quality of print from analyzing an image;

FIG. 3 is a block diagram of another example apparatus to assess a print quality of print from analyzing an image;

FIG. 4 is a block diagram of another example apparatus to assess a print quality of print from analyzing an image; and

FIG. 5 is a flowchart of an example method of assessing a print quality of print from analyzing an image.

### DETAILED DESCRIPTION

Although there may be a trend to paperless technology in applications where printed media has been the standard, such as electronically stored documents in a business, printed documents are still widely accepted and may often be more convenient to use. In particular, printed documents are easy to distribute, store, and be used as a medium for disseminating information. In addition, printed documents may serve as contingency for electronically stored documents, such as may happen when an electronic device fails, such as with a poor data connection for downloading the document and/or a depleted power source. Accordingly, the quality of printed documents is to be assessed to maintain the integrity of the information presented in the printed document as well as to maintain aesthetic appearances.

For example, printing devices may generate artifacts that degrade the quality of printed documents. These artifacts may occur, for example, due to defective toner cartridges and general hardware malfunction. In general, numerous test pages are printed to check for defects both during manufacturing and while a printing device is in use over the life of the printing device. Visually inspecting each printed document by a user may be tedious, time consuming, and error prone. This disclosure includes examples that provide an automated method to segment multiple types of artifacts in printed pages, without using defect-free images for comparison purposes.

To improve the inspection process for printed documents, an apparatus to carry out automated computer vision-based method to detect and locate printing defects in scanned images is provided. In particular, the apparatus carries out the method without comparing a printed document against a reference source image to reduce the amount resources used to make such a comparison. It is to be appreciated by a person of skill in the art that by omitting the comparison with a reference source image, the method used by the apparatus reduces the resources that are to be used to integrate a reference comparison process into a printing workflow. As an example, the apparatus may be used to detect color banding and dark streaks on printed documents using a deep convolutional neural network model. Since high resolution test images may be captured of a printed document, the raw test image may be too large for a standard deep convolutional neural network model application using commonly available computer resources. Accordingly, the test images may be downscaled or reduced. The neural network model may then be applied to the downscaled version of the scanned image to predict regions with printing defects. Alternatively, the neural network model may be applied as a sliding window to provide finer detection by avoiding the resize of the test image at the cost of more processing time.

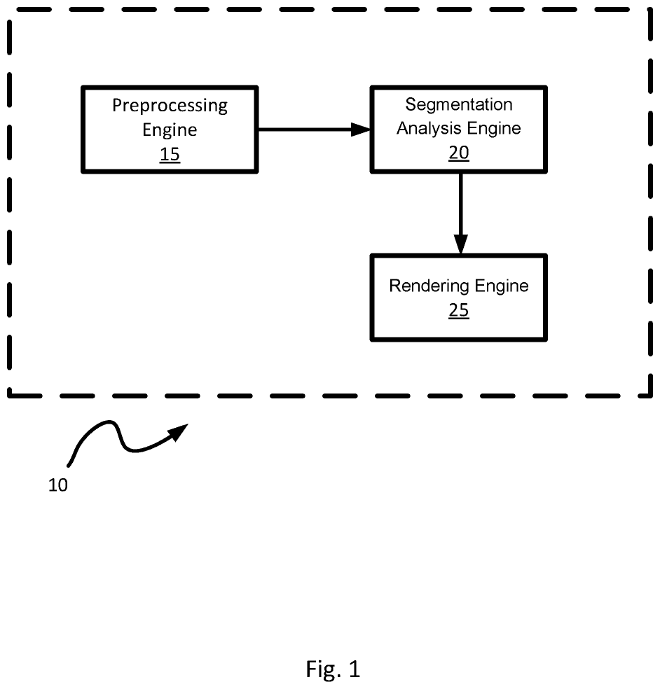

Referring to FIG. 1, an example of an apparatus to assess the print quality of a printed document is generally shown at 10. The apparatus 10 may include additional components, such as various memory storage units, interfaces to communicate with other devices, and further input and output devices to interact with a user or an administrator of the apparatus 10. In addition, input and output peripherals may be used to train or configure the apparatus 10 as described in greater detail below. In the present example, the apparatus 10 includes a preprocessing engine 15, a segmentation analysis engine 20, and a rendering engine 25. Although the present example shows the preprocessing engine 15, the segmentation analysis engine 20, and the rendering engine 25 as separate components, in other examples, the preprocessing engine 15, the segmentation analysis engine 20, and the rendering engine 25 may be part of the same physical component such as a microprocessor configured to carry out multiple functions.

In the present example, the preprocessing engine 15 is to preprocess an original test image of a print into an image having a reduced format, such as a lower resolution. The original test image may be an image of a print to be tested using the print quality assessment procedure described in greater detail below. The resolution of the original test image is not limited and may be any high-resolution image obtained from an image capture device, such as a scanner or camera. As an example, the original test image of the print may be an image with a resolution of 1980×1080 pixels, 3840×2160 pixels, or 7680×4320 pixels. The reduced format includes a predetermined number of pixels. The number and ratio of pixels in the reduced format is not particularly limited and may be selected based on the hardware specifications for the apparatus 10. For example, a smaller reduced format generally provides faster subsequent processing, whereas a larger reduced format provides a more accurate or finer identification of potential defects in the original test image of the print. In the present example, the preprocessing engine 15 may reduce the original test image to a 513×513 array of pixels. In other examples, the reduced format may include a smaller array, such as a 257×257 array of pixels. Alternatively, the reduced format may also be a larger array, such as a 1025×1025 array of pixels. In further example, the array of pixels may not be a square array and may be rectangular, such as a 1280×720 array of pixels, or any other shape.

The manner by which the preprocessing engine 15 modifies the original test image of a print is not particularly limited. For example, the preprocessing engine 15 may use a resize approach where the resolution of the original test image is reduced to an approximate size of 1280×720 pixels. In this approach, the size of the reduced format is approximate since the original aspect ratio of the original test message is to be substantially maintained. The preprocessing engine 15 may use a stepping bicubic interpolation to reduce the resolution of the original test image to the reduced format.

In another approach, the preprocessing engine 15 may divide the original test image into a plurality of patches. Each patch may include a portion of the original test image having a predetermined size of 513×513 pixels. Accordingly, each patch may be subsequently processed separately. Afterwards, the separate patches may be recombined in a post-processing procedure to provide an accurate pixel by pixel assessment of the print quality of the original test image. The original resolution of the test image is to be maintained in each patch such that the patch is a portion of the test image. Accordingly, the whole test image may be divided into a plurality of patches, where the number of patches is dependent on the number of patches is dependent on the resolution of the original test image. The patches may be generated by applying a sliding window having 513×513 pixels. During the generation of the patches, the window may be displaced by a stride distance, such as 513 pixels to include the entire original test image. In other examples, the stride distance may be smaller than the patch size such that the patches overlap. In further examples, the stride distance may also be larger such that fewer patches are generated for subsequent processing to increase the speed of the processing the original test image.

The segmentation analysis engine 20 is to generate a plurality of labels based on the reduced format generated by the preprocessing engine 15. In the present example, the segmentation analysis engine 20 generates a label associated with each pixel in the reduced format. The label is to identify the pixel as being defective or non-defective.

The manner by which the label for each pixel of the reduced format is generated is not particularly limited. For example, the segmentation analysis engine 20 may carry out a machine learning process such as a deep learning technique using convolution neural networks. In particular, the segmentation analysis engine may carry out a semantic segmentation process.

In the present example, the semantic segmentation method may be considered to be a refinement process of the reduced format from coarse understanding to a fine inference using a multi-layer neural network. For example, the first step may involve analyzing the input image, such as the reduced format generated at the preprocessing engine 15 to a prediction for the input image, such as predicting whether the entire image is defective or not. During the next step, localization or detection is used to determine a fine-grained inference, providing the defect locations. Accordingly, semantic segmentation provides a method to obtain fine-grained inferences that may make dense predictions inferring labels for every pixel. Therefore, each pixel may be labeled by the segmentation analysis engine 20 as either defective or non-defective.

It is to be appreciated that the manner by which semantic segmentation is carried out by the segmentation analysis engine 20 is not limited. Since the semantic segmentation is carried out by a deep network architecture, such as a deep convolutional neural network, multiple standard architectures may be used. In the present example, DeepLabv3+ developed by GOOGLE was used to perform the semantic segmentation of the reduced format data. In other examples, other types of deep neural network architectures for semantic segmentation may be used, such as U-Net, Dilated Residual Networks, SegNet, RefineNet, LinkNet or ENet.

The rendering engine 25 is to render output, such as in the form of a visualization of defects. In particular, the rendering engine 25 is to render the plurality of labels generated by the segmentation analysis engine 20. The plurality of labels is used to identify a defect in the image. The manner by which the labels are rendered is not particularly limited. For example, the rendering engine 25 may generate output to be received by a display system, such as a monitor, to display the defects of the reduced format based on the plurality of labels generated by the segmentation analysis engine 20. As another example, the visualization may be a textual visualization where a list of pixel coordinates or a graphical visualization. The specific format of the output rendered by the rendering engine 25 is not limited. For example, the apparatus 10 may have a display (not shown) to receive signals from the rendering engine 25 to display an overlay image of the labels indicating a defective pixel. In other example, the rendering engine 25 may generate reports and/or charts in electronic form to be transmitted to an external device for display. The external device may be a computer of an administrator, or it may be a printing device to generate hardcopies of the results.

In some examples where multiple patches of an original test image are processed by the segmentation analysis engine 20, the rendering engine 25 may combine the plurality of processed patches to provide a pixel by pixel overlay of the patches over the original test image to identify the pixels that are defective based on the analysis of the segmentation analysis engine 20. In examples where the original test image resolution was reduced, the rendering engine 25 may overlay the reduced resolution labels over the original test image to identify the areas of the image that are defective.

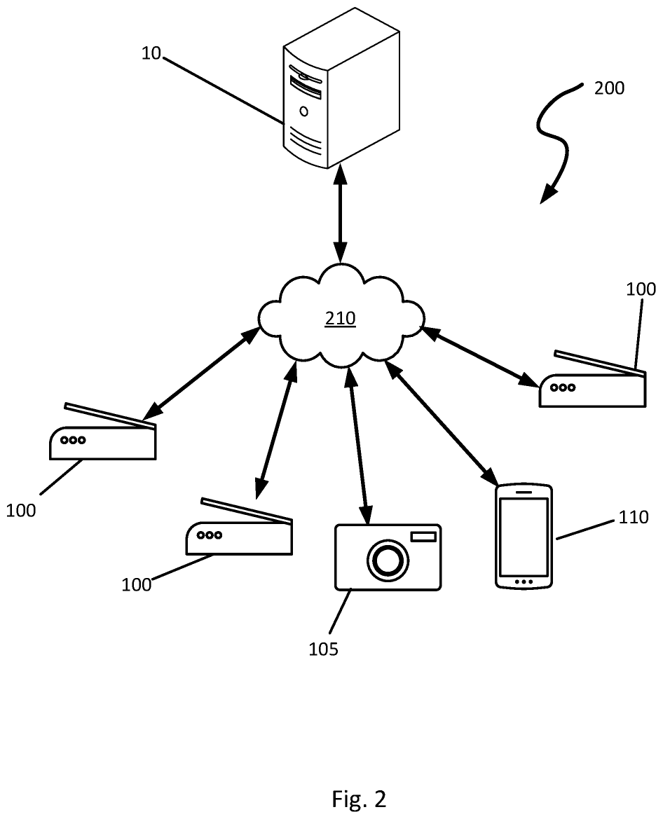

Referring to FIG. 2, an example of a print quality assessment system to monitor prints generated by a printing device generally shown at 200. In the present example, the apparatus 10 is in communication with scanners 100, a camera 105, and a smartphone 110 via a network 210. It is to be appreciated that the scanners 100, the camera 105, and the smartphone 110 are not limited and additional devices capable of capturing an image may be added.

It is to be appreciated that in the system 200, the apparatus 10 may be a server centrally located. The apparatus 10 may be connected to remote devices such as scanners 100, cameras 105, and smartphones 110 to provide print quality assessments to remote locations. For example, the apparatus 10 may be located at a corporate headquarters or at a company providing a device as a service offering to clients at various locations. Users or administrators at each location periodically submit a scanned image of a printed document generated by a local printing device to determine whether the local printing device is performing within specifications and/or whether the local printing device is to be serviced.

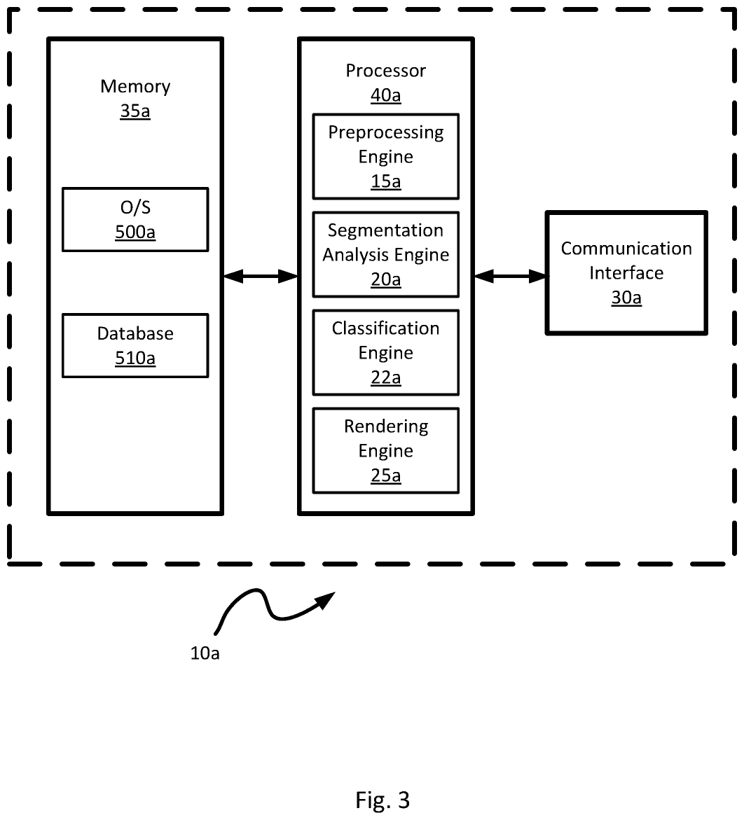

Referring to FIG. 3, another example of an apparatus to assess the print quality of a printed document is shown at 10a. Like components of the apparatus 10a bear like reference to their counterparts in the apparatus 10, except followed by the suffix “a”. The apparatus 10a includes a communication interface 30a, a memory storage unit 35a, and a processor 40a. In the present example, a preprocessing engine 15a, a segmentation analysis engine 20a, a classification engine 22a, and a rendering engine 25a are implemented by processor 40a. It is to be appreciated that the apparatus 10a may be a substitute for the apparatus 10 in the system 200. Accordingly, the following discussion of apparatus 10a may lead to a further understanding of the system 200.

The communications interface 30a is to communicate with external devices over the network 210, such as scanners 100, cameras 105, and smartphones 110. Accordingly, the communications interface 30a may be to receive the original test image from an external device, such as a scanner 100, a camera 105, or a smartphone 110. The manner by which the communications interface 30a receives the telemetry data is not particularly limited. In the present example, the apparatus 10a may be a cloud server located at a distant location from the, such as scanners 100, cameras 105, and smartphones 110, which may be broadly distributed over a large geographic area. Accordingly, the communications interface 30a may be a network interface communicating over the Internet. In other examples, the communication interface 30a may connect to the external devices via a peer to peer connection, such as over a wire or private network.

The memory storage unit 35a is to store original test image data as well as processed data. In addition, the memory storage unit 35a is to maintain a database 510a to store a training dataset. The manner by which the memory storage unit 35a stores or maintains the database 510a is not particularly limited. In the present example, the memory storage unit 35a may maintain a table in the database 510a to store and index the training dataset received by the communication interface 30a. For example, the training dataset may include samples of test images with synthetic artifacts injected into the test images. The test images in the training dataset may then be used to train the model used by segmentation analysis engine 20a and/or the classification engine 22a.

In the present example, the memory storage unit 35a may include a non-transitory machine-readable storage medium that may be, for example, an electronic, magnetic, optical, or other physical storage device. In addition, the memory storage unit 35a may store an operating system 500a that is executable by the processor 40a to provide general functionality to the apparatus 10a. For example, the operating system may provide functionality to additional applications. Examples of operating systems include Windows™, macOS™, iOS™, Android™, Linux™, and Unix™. The memory storage unit 30a may additionally store instructions to operate at the driver level as well as other hardware drivers to communicate with other components and peripheral devices of the apparatus 10a.

The processor 40a may include a central processing unit (CPU), a graphics processing unit (GPU), a microcontroller, a microprocessor, a processing core, a field-programmable gate array (FPGA), an application-specific integrated circuit (ASIC), or similar. As previously discussed, the processor 40a and the memory storage unit 35a may cooperate to execute various instructions. In the present example, the processor 40a may execute instructions stored on the memory storage unit 35a to carry out processes such as to assess the print quality of a received scan of the printed document. In other examples, the processor 40a may execute instructions stored on the memory storage unit 35a to implement the preprocessing engine 15a, the segmentation analysis engine 20a, the classification engine 22a, and the rendering engine 25a. In other examples, the preprocessing engine 15a, the segmentation analysis engine 20a, the classification engine 22a, and the rendering engine 25a may each be executed on a separate processor (not shown). In further examples, the preprocessing engine 15a, the segmentation analysis engine 20a, the classification engine 22a, and the rendering engine 25a may each be executed on a separate machine, such as from a software as a service provider or in a virtual cloud server.

In the present example, the preprocessing engine 15a may further interact with the memory storage unit 35a. In particular, the apparatus 10a may receive original test images at a faster rate than the rate at which the apparatus 10a is capable of processing each image based on the parameters provided. Accordingly, as original test images are received via the communication interface 30a may be stored in a queue on the in the memory storage unit 35a and retrieved by the preprocessing engine 15a from the queue. After the generation of the reduced format, the preprocessing engine 15a may store the reduced format on in the memory storage unit 35a for subsequent retrieval by the segmentation analysis engine 20a.

Similarly, the segmentation analysis engine 20a may further interact with the memory storage unit 35a in the present example. For example, the segmentation analysis engine 20a may use a model such as a convolutional neural network to carry out a semantic segmentation process. In the present example, the segmentation analysis engine 20a may use the training dataset stored in the database 510a to train the convolutional neural network model to be used by the segmentation analysis engine 20a to analyze the reduced format image generated by the preprocessing engine 15a.

Once a pixel has been labelled as defective, a classification engine 22a may be used to further process the pixel. For example, the classification engine 22a may apply an additional model to the defective pixel to determine the type of defect that is occurring at the defective pixel. For example, the classification engine 22a may identify the defect as a streak-type defect. A streak-type defect may be characterized by a decrease in the intensity of a channel in the Red-Green-Blue (RGB) colorspace to generate a darker line during the printing process. As another example of a defect, the classification engine 22a may identify a defect as a band-type defect, which is characterized by a rectangular disturbance in one of the channels in the Cyan-Magenta-Yellow-Key (CMYK) colorspace.

The manner by which the classification engine 22a operates to process a defective pixel is not particularly limited. In the present example, the classification engine 22a may use a rules-based prediction method to analyze the test image. In other examples, machine learning models may be used to predict and/or classify a specific type of defect. For example, the prediction model may be a neural network, such as a convolutional neural network, a recurrent neural network, or another classifier model such as support vector machines, random forest trees, Naïve Bayes classifiers.

It is to be appreciated by a person of skill that by further classifying a defect generated by a printing device, subsequent diagnosis of the issue causing the defect may be facilitated. By increasing the accuracy and objectivity of a diagnosis of a potential issue, a solution may be more readily implemented which may result in an increase in operational efficiency and a reduction on the downtime of a printing device.

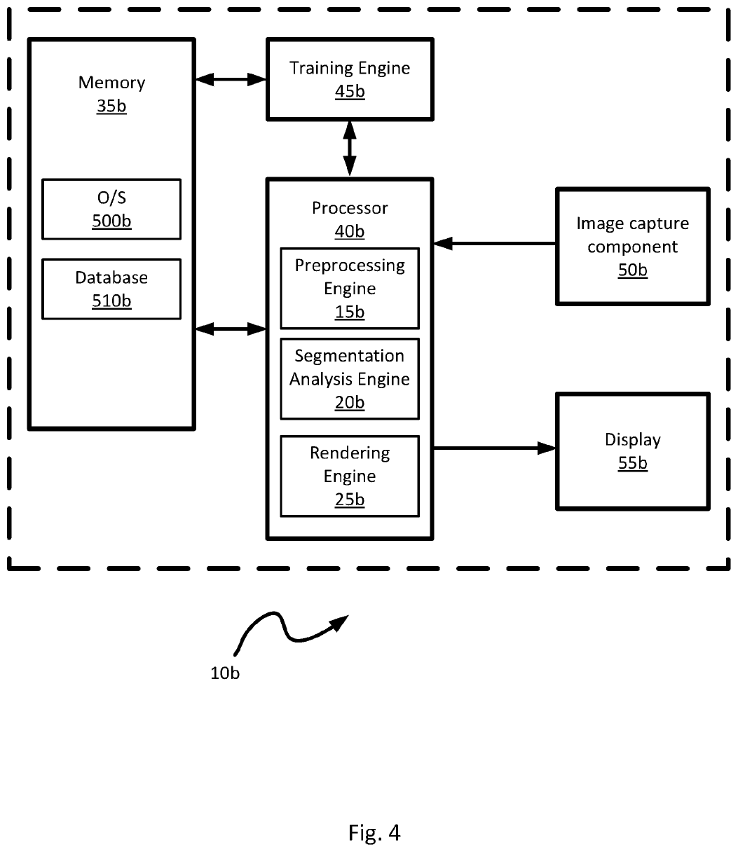

Referring to FIG. 4, another example of an apparatus to assess the print quality of a printed document is shown at 10b. Like components of the apparatus 10b bear like reference to their counterparts in the apparatus 10 and the apparatus 10a, except followed by the suffix “b”. The apparatus 10b includes a memory storage unit 35b, a processor 40b, a training engine 45b, an image capture component 50b, and a display 55b. In the present example, a preprocessing engine 15b, a segmentation analysis engine 20b, and a rendering engine 25b are implemented by processor 40b.

The memory storage unit 35b is to store data used by the processor 40b during normal operation. For example, the memory storage unit 35b may be used to store the original test image as well as intermediate data, such as the reduced format image generated by the preprocessing engine 15b. In addition, the memory storage unit 35b is to maintain a database 510b to store a training dataset. In addition, the memory storage unit 35b may store an operating system 500b that is executable by the processor 40b to provide general functionality to the apparatus 10b.

The training engine 45b is to train a model used by the segmentation analysis engine 20b. The manner by which the training engine 45b trains the convolutional neural network model used by the segmentation analysis engine 20b is not limited. In the present example, the training engine 45b may use images stored in the database 510b to train the convolutional neural network model. For example, the database may include 2949 images with varying dimensions and aspect ratios, but with a minimum resolution of 1980×1080 pixels. Approximately 300 of the images were separated from the other images and used to validate the training after each epoch of the training process. Common data augmentation techniques may be applied to the training images to increase their variability and increase the robustness of the neural network to different types of input sources. For example, adding different levels of blur may help the network handle lower resolution camera images. Another example is adding different amounts and types of statistical noise, which may help the network handle noisy input sources. In addition, horizontal flipping may substantially double the number of training examples. It is to be appreciated that various combinations of these techniques may be applied, resulting in a training set many times larger than the original number of images.

The image capture component 50b is to capture the original test image of a print from a printing device. In particular, the image capture component 50b is to capture the complete image of the print for analysis. The manner by which the image is captured using the image capture component 50b is not limited. For example, the image capture component 50b may be a flatbed scanner, a camera, a tablet device, or a smartphone.

The display 55b is to output the defective pixel over the complete image captured by the image capture component 50b. The manner by which the pixel is displayed on the display 55b is not limited. For example, the rendering engine 25b may generate an augmented image to superimpose pixels that have been identified as defective. In further examples, the rendering engine 25b may superimpose pixels in various colors on the display 55b based on a type of defect to effectively color code the presentation to allow a user to readily identify where the defects are occurring as well as what type of defect is presented.

Accordingly, it is to be appreciated that the apparatus 10b provides a single device that may be used to assess the quality of a print. In particular, since the apparatus 10b includes an image capture component 50b and a display 55b, it may allow for rapid local assessments of print quality.

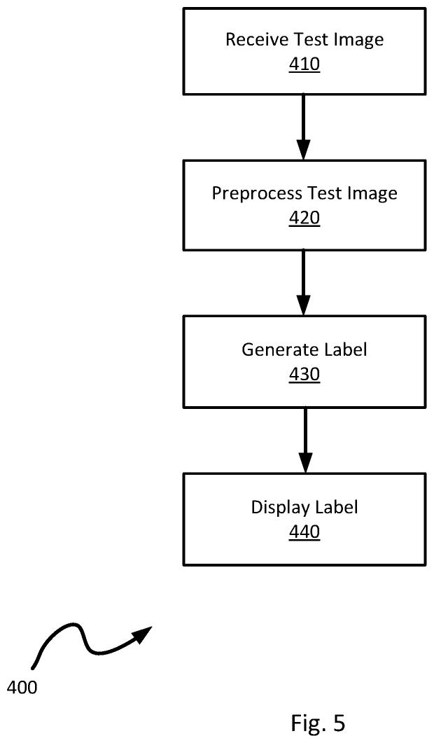

Referring to FIG. 5, a flowchart of an example method of print quality assessments is generally shown at 400. In order to assist in the explanation of method 400, it will be assumed that method 400 may be performed with the system 200. Indeed, the method 400 may be one way in which system 200 along with an apparatus 10 may be configured. Furthermore, the following discussion of method 400 may lead to a further understanding of the system 200 and the apparatus 10. In addition, it is to be emphasized, that method 400 may not be performed in the exact sequence as shown, and various blocks may be performed in parallel rather than in sequence, or in a different sequence altogether.

Beginning at block 410, a test image of a print is received. The manner by which the test image is received is not particularly limited. For example, the test image maybe captured by an external device at a separate location. The test image may then be transmitted from the external device, such as a scanner 100, a camera 105, or a smartphone 110, to the apparatus 10 for additional processing.

Block 420 uses the preprocessing engine 15 to preprocess the test image received at block 410. In the present example, the test image is to be reduced from its original resolution to provide a reduced format image for block 430 that is within reasonable limits such that the processing of the image is not unduly long. The manner by which the preprocessing engine 15 modifies the original test image of a print is not particularly limited. As one example, the preprocessing engine 15 may use a resize approach where the resolution of the original test image is reduced, such as to an approximate size of 1280×720 pixels. In this approach, the size of the reduced format is approximate since the original aspect ratio of the original test message is to be substantially maintained. The preprocessing engine 15 may us a stepping bicubic interpolation to reduce the resolution of the original test image to the reduced format. In other examples, the preprocessing engine may also us other methods, such as bilinear interpolation, spline interpolation, and/or seam carving.

In another approach, the preprocessing engine 15 may divide the original test image into a plurality of patches. Each patch may include a portion of the original test image having a predetermined size of 513×513 pixels. Accordingly, each patch may be subsequently processed separately and may be recombined in a post-processing procedure to provide an accurate pixel by pixel assessment of the print quality of the original test image. The original resolution of the test image is to be maintained in each patch such that the patch is a portion of the test image. Accordingly, the whole test image may be divided into a plurality of patches, where the number of patches is dependent on the number of patches is dependent on the resolution of the original test image. The patches may be generated by applying a sliding window having 513×513 pixels. During the generation of the patches, the window may be displaced by a stride distance, such as 513 pixels to include the entire original test image. In other examples, the stride distance may be smaller than the patch size such that the patches overlap. In further examples, the stride distance may also be larger such that fewer patches are generated for subsequent processing to increase the speed of the processing the original test image.

Block 430 involves generating a label for each pixel in the reduced format image generated at block 420. In the present example, the label is to identify each pixel as being defective or non-defective. The manner by which the label for each pixel of the reduced format is generated is not particularly limited. For example, the segmentation analysis engine 20 may carry out a machine learning process such as a deep learning technique using convolution neural networks. In particular, the segmentation analysis engine may carry out a semantic segmentation process. In some examples, pixels that have been identified as defective may also be further classified to determine the type of defect that is exhibited at the pixel.

Block 440 displays the pixel along with a label. It is to be appreciated that the manner by which the label is presented with the pixel is not limited. For example, for pixels with a non-defective label, the pixel may simply be presented on a display as in the original test image. For pixels with a label of defective, a visual cue, such as a highlight color, or other indication may be superimposed over the pixel. Accordingly, a user reviewing the results of the print assessment may readily identify the pixels having defects. It is to be appreciated that other presentation schemes may be used.

Various advantages will now become apparent to a person of skill in the art. For example, the system 200 may provide an objective manner for print quality assessments to aid in the identification of defects at a printing device. Furthermore, the method may also identify issues with print quality before a human eye is able to make such a determination. In particular, this will increase the accuracy of the analysis leading to improved overall print quality from printing devices.

It should be recognized that features and aspects of the various examples provided above may be combined into further examples that also fall within the scope of the present disclosure.

What is claimed is:

1. An apparatus comprising:
a preprocessing engine to preprocess an image of a print into a reduced format wherein the reduced format includes a plurality of pixels;
a segmentation analysis engine to generate a plurality of labels, wherein each label of the plurality of labels is associated with a pixel of the plurality of pixels, wherein the plurality of labels identifies each pixel of the plurality of pixels as a defective pixel or a non-defective pixel; and
a rendering engine to render the plurality of labels, wherein the plurality of labels is to identify a defect in the image.

2. The apparatus of claim 1, wherein the preprocessing engine reduces a resolution of the image.

3. The apparatus of claim 1, wherein the preprocessing engine extracts a plurality of patches from the image, wherein a patch selected from the plurality of patches is the reduced format.

4. The apparatus of claim 1, further comprising a classification engine to process the defective pixel.

5. The apparatus of claim 4, wherein the classification engine classifies the defective pixel as a streak-type defective pixel.

6. The apparatus of claim 4, wherein the classification engine classifies the defective pixel as a band-type defective pixel.

7. The apparatus of claim 1, further comprising a communication interface to receive the image.

8. The apparatus of claim 1, further comprising a memory storage unit to store a training dataset, wherein the segmentation analysis engine uses a model trained with the training dataset to analyze the reduced format.

9. A device comprising:
an image capture component to capture a complete image of a print;
a preprocessing engine to preprocess the complete image into a reduced format image;
a memory storage unit to store and the reduced format image;
a segmentation analysis engine to generate a label, wherein the label is associated with a pixel of the reduced format image, wherein the segmentation analysis engine uses a model to analyze the reduced format image, wherein the label identifies the pixel as a defective pixel or a non-defective pixel; and
a display to output the defective pixel over the complete image.

10. The device of claim 9, wherein the reduced format image is a patch of the complete image.

11. The device of claim 9, further comprising a classification engine to process the defective pixel.

12. The device of claim 11, wherein the classification engine classifies the defective pixel as a streak-type defective pixel.

13. The device of claim 11, wherein the classification engine classifies the defective pixel as a band-type defective pixel.

14. A method comprising:
receiving a test image of a print;
preprocessing the test image into a reduced format image wherein the reduced format image;
generating a label associated with a pixel of the reduced format image, wherein the label identifies the pixel as a defective pixel or a non-defective pixel; and
displaying the pixel with the label to identify a defect in the print.

15. The method of claim 14, further comprising classifying the defective pixel based on a type of defect.
